(19) United States
(12) Patent Application Publication
(10) Pub. No.: US 2009/0139313 A1
(43) Pub. Date: Jun. 4, 2009

(54) Time-Tagged Data for Atomic Force Microscopy

(76) Inventors: David Patrick Fromm, Palo Alto, CA (US); Richard Kenton Workman, Sunnyvale, CA (US); John Paul Flowers, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/949,578

(22) Filed: Dec. 3, 2007

(51) Int. Cl. G01B 5/28

(52) U.S. Cl. 73/105

(57) ABSTRACT

A scanning probe microscope and method for using the same are disclosed. The scanning probe microscope includes a probe, an electromechanical actuator that moves the sample relative to the probe, an external interface, and a controller. The probe has a tip that moves in response to an interaction between the tip and a local characteristic of a sample. The external interface provides a connection between the scanning probe microscope and a device external to the scanning probe microscope. The controller records scanning probe microscope data measurements, each scanning probe microscope data measurement including a location of the probe in the three dimensions and a label that uniquely identifies that measurement and allows that measurement to be correlated with data generated by a device that is external to the scanning probe microscope. The unique label could include the time at which the data measurement was made.

### BACKGROUND OF THE INVENTION

Scanning probe microscopy is a class of imaging techniques in which a tip that interacts locally with a sample is scanned over the surface of the sample to generate a three-dimensional image representing the properties of the surface. This type of microscope can provide images of molecules and surfaces at the atomic level under ambient conditions without damaging the sample. As a result, these microscopes are being utilized in a wide range of research fields including semiconductors and biology.

In atomic force microscopy, the surface interaction force between the probe tip and the sample are measured at each point on the sample. The tip has a very sharp end and is mounted on the end of a cantilevered arm. As the tip is moved over the surface of the sample, the arm deflects in response to changes in the tip/sample forces and local variation of sample topography. Images are typically acquired in one of two modes. In the contact or constant force mode, the tip is brought into contact with the sample and the tip moves up and down as the tip is moved over the surface. The deflection of the arm is a direct measure of force and topographical variations. A feedback controller measures the deflection and adjusts the height of the probe tip so as to maintain constant force between the cantilevered probe and the surface, i.e., the arm at a fixed deflection.

In the AC, or non-contact mode, the tip and arm are oscillated at a frequency near the resonant frequency of the arm. The height of the tip can be controlled such that the tip avoids contact with the sample surface, sampling short-range tip/sample forces. Short-range attractive forces between the tip and the sample result in changes in the oscillations of the cantilever. Alternatively, the tip can be allowed to make light intermittent contact with the sample only at the bottom of the oscillation cycle. These attractive and/or repulsive interactions between the probe tip and the sample result in an alteration of the amplitude, phase and/or frequency of the oscillation. The controller adjusts the height of the probe over the sample such that the oscillation amplitude, phase and/or frequency is kept at a predetermined constant value. Since the tip is not in constant contact with the sample, the lateral forces applied to the sample are significantly less than in the mode in which the tip is in constant contact. For soft samples, this mode reduces the damage that the tip can inflict on the sample and also provides a more accurate image of the surface in its non-disturbed configuration.

The simplest form of imaging is a plot of the variations in the height of the probe over the sample as a function of the (x,y) coordinates of the tip. For example, the tip can be moved relative to the sample by mounting the sample on a stage that includes actuators that move the stage relative to the tip. Such images provide information about the surface topography of the sample, but provide only limited information about other sample properties. To provide additional information on the other properties of the structures in the sample, additional measurements are needed at each sample point.

For example, a separate electrical measurement can be made at each point on the sample simultaneous with the topography measurement. Such measurements could include the capacitance of the local tip/sample region, or the resistance of a circuit that includes the tip and the sample. In addition, features on the surface could be excited by signals applied to the probe. The properties of the excited structures could then be measured.

In principle, these new types of measurements can be included in a microscope system by the manufacturer. For example, additional circuitry for generating the electrical signals and measuring the electrical properties of the probe could be incorporated into the existing microscope systems along with the software that implements the new test at each point in the scan. However, such an approach requires a significant development investment by the manufacturer for each new test that is devised. Hence, unless a new test has a market that is sufficient to amortize the development costs, a test will not be added to the existing microscope models. In addition, developing new tests is impeded, since individuals who are not affiliated with the manufacturer often do not have access to the internal software and hardware of the existing microscopes, and hence, cannot easily develop a new test on an existing model of the microscope.

### SUMMARY OF THE INVENTION

The present invention includes a scanning probe microscope and method for using the same. The scanning probe microscope includes a probe, an electromechanical actuator, an external interface, and a controller. The probe has a tip that moves in response to an interaction between the tip and a local characteristic of a sample. The electromechanical actuator moves the sample relative to the probe tip in three dimensions. The external interface provides a connection between the scanning probe microscope and a device external to the scanning probe microscope. The controller causes the electromechanical actuator to move said sample relative to said probe tip. The controller records a plurality of scanning probe microscope data measurements, each scanning probe microscope data measurement including a location of the probe in the three dimensions and a label that uniquely identifies that measurement and allows that measurement to be correlated with data generated by a device that is external to the scanning probe microscope. The controller can output or receive a synchronization signal that allows the external device to correlate measurements made by the external device with the recorded scanning probe microscope data measurements. In one aspect of the invention, the unique label includes the time on a clock in the controller at which the data measurement was made.

### BRIEF DESCRIPTION OF THE DRAWINGS

FIG. 1 illustrates a typical prior art atomic force microscope that utilizes the scanning probe microscope of the present invention.

FIG. 2 illustrates an atomic force microscope according to one embodiment of the present invention.

### DETAILED DESCRIPTION OF THE PREFERRED EMBODIMENTS OF THE INVENTION

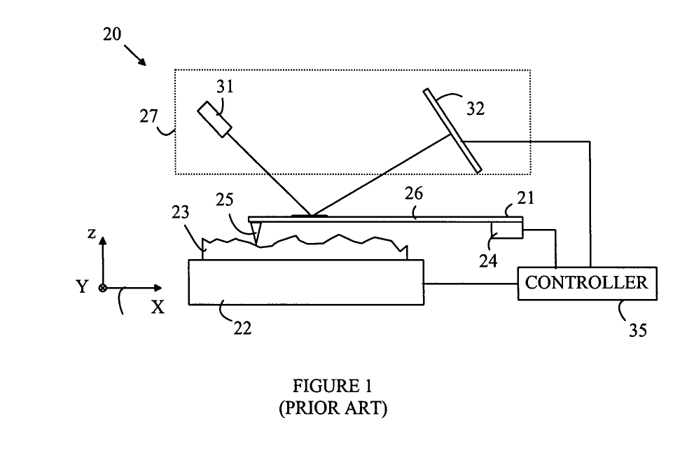

The manner in which the present invention provides its advantages can be more easily understood with reference to FIG. 1, which illustrates a typical atomic force microscope. Microscope 20 includes a probe assembly 21 and a stage 22 on which a sample 23 to be imaged is mounted. A combination of actuators move the stage and probe relative to one another in three orthogonal directions. In the case of microscope 20, stage 22 moves the sample in an x-y plane under the probe assembly 21. Probe assembly 21 is attached to a second actuator 24 that moves probe assembly 21 in a z-direction that is perpendicular to the x-y plane. However, embodiments that use other mechanisms to move the probe relative to the sample with the required three degrees of freedom could also be utilized.

Probe assembly 21 includes a tip 25 that is mounted on an arm 26 that can deflect. The degree of deflection of arm 26 is measured by a detector 27. In the embodiment shown in FIG. 1, the detector 27 includes a light source 31 and photodetector 32. Light source 31 illuminates a reflector on arm 26, and the location of the reflected light is detected by photodetector 32. A servo loop is utilized by controller 35 to set the z-coordinate through actuator 24 such that the deflection of arm 26 is maintained at a predetermined value. The z-coordinate of the actuator relative to the sample as a function of the (x,y) position of the stage provides a three-dimensional topographic map of the sample surface.

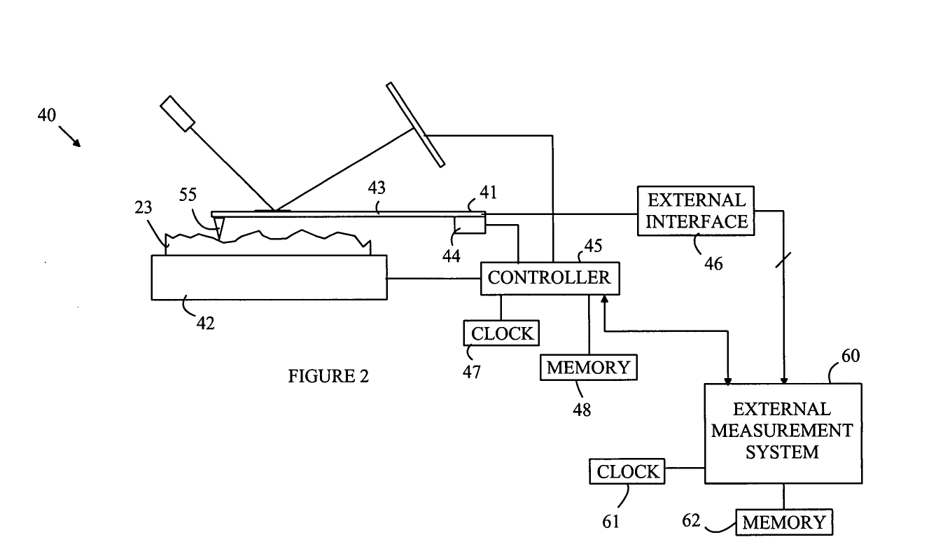

Refer now to FIG. 2, which illustrates an atomic force microscope according to one embodiment of the present invention. Atomic force microscope 40 is similar to atomic force microscope 20 discussed above in that it includes a probe assembly 41 having a tip 55 whose vertical position is adjusted by a servo loop and actuator 44 such that arm 43 maintains a predetermined degree of deflection as probe tip 55 moves relative to sample 23 in response to signals from a controller 45 to a stage 42 on which sample 23 is mounted. In this embodiment, probe tip 55 is constructed from a conductive material and is connected electrically to an external interface 46 whose output can be connected to an external measurement system 60. External interface 46 is also electrically connected to sample 23 and that connection is also made available through external interface 46. To simplify the drawing, the connections between sample 23 and external interface 46 have been omitted from the drawing.

Controller 45 includes a memory 48 in which data on the position of the sample and height of actuator 44 are recorded as probe tip 55 moves relative to sample 23. In addition, each (x,y,z) measurement is augmented with a time reading generated with the aid of an internal clock 47. As will be explained in more detail below, the time stamp on each data point allows the external measurement system to match data taken in that system with the measurements made by the probe microscope.

The external measurement system can be any system that makes a measurement based on probe-sample interaction or generates a stimulus that is applied to the sample. In this embodiment, the external measurement is based on the electrical characteristics of the probe-sample interaction. Other embodiments that operate by applying a stimulus to the sample or utilize different forms of external measurements will be discussed in more detail below. For example, the external measurement system could measure the capacitive coupling of the probe tip and sample. In the simplest case, the external measurement system runs a synchronously with respect to atomic force microscope 40. External measurement system 60 makes whatever predetermined measurement that it is programmed to make and records the data in a memory 62 together with a time stamp that references the time on a clock 61 that is part of external measurement system 60.

After the scan is completed, the data from memory 62 and the data in memory 48 are processed. The processing can be performed in external measurement system 60 or another data processing system. To match the data taken by external measurement system 60 to that taken by atomic force microscope 40, the offset between clocks 47 and 61 must be known. This information can be provided by comparing the contents of clock 61 with a clock setting message from controller 45 in which controller 45 sends the current time on clock 47. This message can be sent periodically by controller 45 either via a separate interface line or on one of the lines from external interface 46. Alternatively, controller 45 could send the message in response to a query from the external measurement system. Embodiments in which a master clock that is external to both the external measurement system and the atomic force microscope could also be utilized to synchronize the clocks in the two systems and maintain those clocks in a synchronized state.

Once the relationships between the time stamps on the data from atomic force microscope 40 and the time stamps on the data from external measurement system 60 is known, the data from external measurement system 60 can be used to generate a separate image of the sample based on the measurements made by external measurement system 60. To generate an image from the data collected by external measurement system 60, the (x,y) location of stage 42 at the time external measurement system 60 made the measurement is needed. The time stamp data from atomic force microscope 40 provides a mapping of the time the measurement was made by atomic force microscope 40 and the (x,y) location at that time. Since the time stamp on the data from external measurement system 60 can be translated to a time on clock 47 by synchronization message information, the (x,y) location can be determined for each measurement made by external measurement system 60. Hence, an image based on the measurement made by external measurement system 60 either alone or in combination with the data recorded by atomic force microscope 40 can be constructed.

It should be noted that this new image can be made without altering the programming of atomic force microscope 40. Once atomic force microscope 40 has been modified to provide the time stamps on the data recorded by atomic force microscope 40 and the external interface has been provided, new experimental systems can be setup without the need to make further alterations in atomic force microscope 40. Hence, users of atomic force microscope 40 can devise and implement new measurements without requiring the involvement of personnel from the atomic force microscope vendor. In addition, the final image generation can be performed on a general purpose computing platform that is independent of both atomic force microscope 40 and external measurement system 60. This further reduces the investment required to make novel measurements of a particular sample.

It should also be noted that the time stamp system of the present invention can be added to more complex atomic force microscopes that perform other measurements besides the simple height measurement discussed above. Any additional measurements made by the atomic force microscope can be combined with the data provided by external measurement system 60 after the measurements have been made.

The above-described embodiments utilize a time stamp to provide the synchronization of the data taken by atomic force microscope 40 and external measurement system 60. The time stamp mechanism is particularly attractive since an atomic force microscope typically has some form of clock. Many atomic force microscopes are constructed with general purpose data processing circuitry in the controller. Such systems include clocks, and hence, adding a time stamp to the data that is already collected requires very little additional programming. In addition, the synchronization of the two systems requires only a single communication at some time that is close to that at which data is being taken, since the two clocks are typically controlled to a precision that allows the clocks to remain synchronized over the period of time during which data is being taken.

However, embodiments that utilize other mechanisms for synchronizing the two data sets can also be constructed. In principle, any type of atomic force microscope synchronization code that is recorded with the data on atomic force microscope 40 and that can be synchronized with an external measurement system synchronization code utilized on external measurement system 60 can be utilized. In one embodiment, controller 45 causes the external interface to output the current time on clock 47 at regular intervals or when controller 45 records a data measurement in memory 48. In this case, external measurement system 60 is always synchronized with atomic force microscope 40. In addition, external measurement system 60 could use the time stamp sent by atomic force microscope 40 in place of the time from clock 61 as the time stamp recorded for data stored in memory 62.

In another embodiment, controller 45 outputs the current (x,y) coordinates of stage 42 at regular intervals or each time a data measurement is recorded in memory 48. External measurement system 60 would then utilize these (x,y) values to tag the measurements made on external measurement system 60. If external measurement system 60 makes measurements faster than atomic force microscope 40, external measurement system 60 can append a sequence code or time code to each measurement in addition to the position data. This embodiment has the advantage of not requiring alterations in the manner in which data is stored in atomic force microscope 40. However, it requires that external measurement system 60 be programmed to accept the data in a predetermined format.

In the above-described embodiments, atomic force microscope 40 and external measurement system 60 operate a synchronously with respect to one another. Additionally, the rate at which measurements are made in each device will, in general, not be the same. External measurement system 60 may have the capability of making more measurements per unit time than atomic force microscope 40. In the case of time stamping, the data in external measurement system 60 could be interpolated to provide the (x,y) coordinates of the points even though atomic force microscope 40 did not take points at the corresponding times.

In the above-described embodiments of the present invention, the atomic force microscope operates independently of the external measurement system. The results of each of the devices measurements are combined after the devices have completed their respective measurements. However, embodiments in which the external measurement system provides control signals to the atomic force microscope could also be constructed. In one embodiment of the present invention, the atomic force microscope accepts commands that define a region that is to be scanned. Initially, the atomic force microscope scans the sample using a coarse resolution to improve the speed of measurement. When the external measurement system detects a point of interest, the external measurement system sends a command to the atomic force microscope that includes the time stamp of the point of interest, the area to be scanned around this point, and the resolution to be utilized. The two systems then resume their asynchronous data collection. This embodiment assumes that the clocks with each instrument have been synchronized before the measurements commence in the case of embodiments that utilize time stamps generated by independent clocks. In embodiments in which the atomic force microscope sends time or position data to the external measurement system, the external measurement system can refer to the point of interest in terms of the time on the atomic force microscope clock or the position that was sent when the point of interest was identified.

It should be noted that many atomic force microscopes have a controller that receives commands from a user through a keyboard or the like. These commands already define the area of the scan, resolution, and other parameters. Hence, this embodiment of the present invention can be implemented with relatively minor changes to the operating system of the atomic force microscope by making the existing control interface available to a remote device.

The above-described embodiments of the present invention utilize an external device interface and additional communication paths for sending commands and synchronization signals between the atomic force microscope and the external measurement system. However, the additional paths can be viewed as part of the external device interface.

In the above-described embodiments, an external measurement that relied on the electrical properties of the probe-sample interaction was utilized. A number of different properties could be utilized. For example, in one type of scanning probe microscope referred to as a Scanning Tunneling Microscope (STM), a conductive tip is scanned over a conductive sample and an electric field is applied between the tip and the sample. At small tip/sample separation, the electron tunneling current is very sensitive to local sample properties and tip/sample separation. One embodiment of this invention for STM would involve measurement of the tip temperature by measuring the electrical resistance of the tip. The temperature measurements could, in turn, be used to control a heating/cooling control loop at particular sample locations or at various times. Another example relevant to STM involves synchronizing an external circuit that measures ballistic electron emission from an STM sample into a substrate (Ballistic Electron Emission Microscopy (BEEM)). With proper time synchronization, the BEEM current can easily and accurately be externally collected and later combined with the STM image data. Other exemplary measurements could be made based on the frequency spectra of the electrical response from the tip using a spectrum analyzer.

The embodiments described above utilize some electrical property of the tip to provide the external measurement. However, an external measurement system that does not rely on such electrical properties of the probe could also be constructed. For example, the external measurement system could measure the properties (wavelength, intensity, etc) of light leaving the sample in the region of the probe tip when light of a predetermined spectrum is applied in the region of the probe.

External systems that apply a stimulus to the sample could also be utilized. The systems discussed above in which the external measurement system applies a light signal to the sample or changes the temperature of the sample are examples of such stimuli. The stimulus could be applied based on some measurement of the probe properties or position. Stimuli based on the application of electric or magnetic fields to the sample could also be utilized.

Various modifications to the present invention will become apparent to those skilled in the art from the foregoing description and accompanying drawings. Accordingly, the present invention is to be limited solely by the scope of the following claims.

What is claimed is:

1. A scanning probe microscope comprising:
a probe having a tip that moves in response to an interaction between said tip and a local characteristic of a sample;
an electromechanical actuator for moving said sample relative to said probe tip in three dimensions;
an external interface that provides an electrical connection between said scanning probe microscope and a device external to said scanning probe microscope; and
a controller that causes said electromechanical actuator to move said sample relative to said probe tip, said controller recording a plurality of scanning probe microscope data measurements, each scanning probe microscope data measurement comprising a location of said probe in said three dimensions and a label that uniquely identifies that measurement and allows that measurement to be correlated with data generated by a device that is external to said scanning probe microscope.

2. The scanning probe microscope of claim 1 wherein said controller maintains a predetermined relationship between said probe and said sample.

3. The scanning probe microscope of claim 1 wherein each of said scanning probe microscope data measurements is generated at different locations.

4. The scanning probe microscope of claim 1 wherein said controller outputs a synchronization signal that allows said external device to correlate measurements made by said external device with said recorded scanning probe microscope data measurements.

5. The scanning probe microscope of claim 1 wherein said controller receives a synchronization signal that allows said external device to correlate measurements made by said external device with said recorded scanning probe microscope data measurements.

6. The scanning probe microscope of claim 1 wherein said external interface provides an electrical connection to said probe.

7. The scanning probe microscope of claim 1 wherein said controller comprises a clock that provides time readings and said label comprises said time reading when said scanning probe microscope data measurement was measured.

8. The scanning probe microscope of claim 7 wherein said controller outputs at least one time reading from said clock on said external interface as said synchronization signal.

9. The scanning probe microscope of claim 1 wherein said synchronization signal comprises said label that is recorded each time one of said scanning probe microscope data measurements is made, said controller outputting said synchronization signal each time a scanning probe microscope data measurement is made within a predetermined time of said measurement.

10. The scanning probe microscope of claim 1 wherein said controller receives external commands on said external interface that determine a scanning pattern made by said scanning probe microscope.

11. The scanning probe microscope of claim 1 wherein said external interface provides an interface for applying a stimulus signal to said sample, said stimulus signal being generated by said external device.

12. A method of operating a scanning probe microscope comprising:
providing a probe having a tip that moves in response to an interaction between said tip and a local characteristic of a sample;
moving said sample relative to said probe tip;
providing an external interface between said scanning probe microscope and a device external to said scanning probe microscope that allows a device that is external to said scanning probe microscope to make measurements on said sample or to provide stimuli to said sample; and
recording a plurality of scanning probe microscope data measurements, each scanning probe microscope data measurement being generated at a different location and comprising a location of said probe in said three dimensions and a label that uniquely identifies that measurement and allows that measurement to be correlated with data generated by said external device; and

13. The method of claim 12 wherein said a predetermined relationship is maintained between said probe and said sample.

14. The method of claim 12 further comprising outputting a synchronization signal that allows said external device to correlate measurements made by said external device with said recorded scanning probe microscope data measurements.

15. The method of claim 12 wherein said label comprises a time indicating when said scanning probe microscope data measurement was measured.

16. The method of claim 15 further comprising outputting at least one time reading that can be used to synchronize an external clock with said scanning probe microscope.

17. The method of claim 12 further comprising outputting said label each time a scanning probe microscope data measurement is made within a predetermined time of said measurement.

18. The method of claim 12 receiving external commands on said external interface that determine a scanning pattern made by said method.
